(19) United States
(12) Patent Application Publication
(10) Pub. No.: US 2005/0061732 A1
(43) Pub. Date: Mar. 24, 2005

(54) Novel inorganic nanofiltration membranes

(76) Inventors: Andre Grangeon, Valreas (FR); Philippe Lescoche, Faucon (FR)

Correspondence Address: Clark & Brody, Suite 600, 1750 K Street NW, Washington, DC, 20006, US

(21) Appl. No.: 10/490,411

(22) PCT Filed: Sep. 25, 2002
(86) PCT No.: PCT/FR02/03265

(30) Foreign Application Priority Data
Sep. 26, 2001 (FR) 01/12362

(51) Int. Cl. B01D 71/02

(52) U.S. Cl. 210/490; 210/504; 210/509

(57) ABSTRACT

The present invention concerns an inorganic nanofiltration membrane characterized in that it comprises: a titanium oxide macroporous support, one or several intermediate separation layers, an upper metal oxide nanofiltration separation layer.

The present invention pertains to the area of membrane separating techniques. The subject of this invention is more particularly inorganic nanofiltration membranes.

Separation methods using membranes are used in numerous sectors, in particular in the environments of potable water production and the treatment of industrial waste, in the chemical, petrochemical, pharmaceutical, agro-foodstuff industries and in the area of biotechnology.

A membrane forms a thin selective barrier and under the action of transfer forces it enables the passing or retention of some components in the medium to be treated. The passing or retention of components may result from their size relative to the pore size of the membrane which then acts as a filter. In relation to the size of the pores, these techniques are called microfiltration, ultrafiltration, or nanofiltration.

Membranes of different structure and texture exist. Some are made of organic materials, of synthetic polymer type and are called organic membranes, others are made of inorganic materials and are called inorganic membranes.

Inorganic membranes generally consist of a macroporous support 0.5 to 3 mm thick, which imparts mechanical resistance to the membrane. The support is generally carbon, alumina-titanium, silico-aluminate or silicon carbide. On this support, one or more layers a few microns thick are deposited ensuring the separation and are called separation layers. The diameter of the pores is chosen in relation to the size of the species to be separated. These layers generally consist of metallic oxides, glass or carbon and are bonded together and to the support by sintering. The support and separation layers differ in particular through their mean pore diameters or porosity or through different densities. The notions of separation layer for microfiltration, ultrafiltration and nanofiltration are well known to persons skilled in the art. It is generally acknowledged that:
the supports have a mean pore diameter of between 2 and 10 μm and a density of between 3000 and 6000 g/m²,
microfiltration separation layers have a mean pore diameter of between 0.1 and 2 μm and a density of between 30 and 60 g/m²,
ultrafiltration separation layers have a mean pore diameter of between 0.02 and 0.1 μm and a density of between 5 and 10 g/m²,
nanofiltration separation layers have a mean pore diameter between 0.5 and 2 nm and a density of between 1 and 5 g/m².

Nanofiltration is a relatively recent separating technique using a pressure-driven membrane. Nanofiltration covers a separation area ranging between ultrafiltration and reverse osmosis.

Nanofiltration membranes are generally in the form of:
a macroporous support having good mechanical resistance,
a mesoporous intermediate separation layer ensuring the link between the support and the active layer,
an active upper nanofiltration separation layer whose pore diameters are in the order of one nanometre, ensuring the separation of molecular or particle species.

Most nanofiltration membranes developed to date are organic membranes or are mixed organic and inorganic membranes, and on this account have unsatisfactory thermal, chemical and mechanical resistance.

The organic membranes have the disadvantage of offering low thermal resistance, generally lower than 100° C. and of being too sensitive to some chemical compounds such as oxidants or organic solvents.

The development of organic nanofiltration membranes for the treatment of industrial waste, or for the chemical or petrochemical industries is therefore limited.

Hence there is a current need for new inorganic nanofiltration membranes.

One of the objectives of the present invention is precisely to provide new inorganic nanofiltration membranes having good mechanical, thermal and chemical resistance and therefore a long lifetime.

The subject of the invention is therefore an inorganic nanofiltration membrane comprising:
a titanium oxide macroporous support,
one or several intermediate separation layers,
an upper metal oxide nanofiltration separation layer.

The inorganic nanofiltration membranes of the invention have a cutoff threshold of between 100 and 2000 daltons, preferably between 800 and 2000 daltons.

The macroporous support in titanium oxide may be produced conventionally by sintering titanium oxide particles. Titanium oxide is generally in rutile form. This support has high porosity, preferably greater than 30%, and a mean thickness of between 0.3 and 5 mm.

This support may have a planar or tubular conformation and possibly a multichannel conformation.

The separation layers may consist of metal oxides, chosen for example from among the oxides of the following metals: aluminium, titanium, zirconium or a mixture of these metals. In particular, the upper nanofiltration separation layer is preferably in titanium oxide.

The inorganic nanofiltration membrane of the invention comprises an intermediate separation layer positioned between the upper nanofiltration separation layer and the support, ensuring the connection between these two. This intermediate separation layer is a microfiltration layer for example.

This intermediate separation layer may also comprise an ultrafiltration layer in metal oxide, deposited on a microfiltration layer in metal oxide, itself deposited on the support. In this case, the nanofiltration layer is deposited on the ultrafiltration layer.

The microfiltration and ultrafiltration layers are deposited using techniques well known to persons skilled in the art. The microfiltration layer for example may be deposited by coating followed by sintering.

Advantageously, the microfiltration layer and the ultrafiltration layer respectively have a mean thickness of between 5 and 50 μm and of between 2 and 10 μm. The microfiltration layer is preferably in titanium oxide and the ultrafiltration layer in titanium oxide or zirconium.

The nanofiltration layer in metal oxide is advantageously obtained using a sol-gel type method.

This nanofiltration layer can be obtained using a method comprising the following steps:
formation of a sol by polycondensation of an alkoxide of the corresponding metal in an alcohol medium and in the presence of a chelating agent,
depositing said sol on the support or intermediate separation layer,
drying said sol to form a gel,
sintering the gel obtained.

In this case, partial hydrolysis of the metal alkoxide is obtained, hydrolysis being controlled by the chelating agent. Heat treatment is used to complete the formation of the oxide and to create porosity. Persons skilled in the art are able to choose the operating conditions for preparing the sol, drying and sintering to achieve the desired porosity.

The nanofiltration layer of metal oxide can also be obtained by a method differing from the preceding method in its first step which consists of forming a sol by hydrolysis of an alkoxide of the corresponding metal followed by peptization.

In this case, the hydrolysis of the metal alkoxide, preferably conducted in a water/acid mixture, is full hydrolysis. A mixture of a metal hydroxide and amorphous or crystallized oxide is obtained which is deflocculated in an acid medium to obtain a stable suspension of crystallized metal oxide.

The invention will be better understood through the following examples which illustrate the invention without restricting it however.

In the examples given below, the supports used are tubular with an outer diameter of 10 mm and an inner diameter of 6 mm. The supports according to the invention are in titanium oxide. By way of comparison, supports in alumina and zirconium may also be used. The supports having the following characteristics are prepared using methods well known to persons skilled in the art:
support in titanium oxide:
   sintering temperature: 1390° C.
   mean pore diameter: 6 μm, porosity 35%
   wetting angle with water: 66°
support in alumina:
   sintering temperature: 1730° C.
   mean pore diameter: 4.5 μm, porosity 31%
   wetting angle with water: 0.5°
support in zirconium:
   sintering temperature: 1840° C.
   mean pore diameter: 2.1 μm, porosity 37%
   wetting angle with water: 32°.

These supports therefore have very different wetting angles. These wetting angles were determined using a method based on measurement of the flow rate of a column of powder obtained by pulverizing the support to be tested. Application of Poiseuille's law to the flow rate was used to calculate the value of the wetting angle.

On these three types of supports, microfiltration layers in titanium oxide are deposited having a mean pore diameter of 0.2 μm.

These deposits are performed in conventional manner by depositing titanium oxide having a mean pore diameter of 0.2 μm in the form of a stable suspension, using an appropriate surfactant.

After depositing, sintering at a temperature of 1050° C. leads to obtaining this mean pore diameter value of 0.2 μm. On these microfiltration layers, either a nanofiltration layer is directly deposited following the two methods described below, or an ultrafiltration layer.

The ultrafiltration layer is made with titanium oxide or zirconium oxide using a sintering temperature that can achieve a membrane cutoff power in the order of 50 KD (KiloDalton).

A nanofiltration layer is then deposited on these ultrafiltration layers.

The nanofiltration layers are made using the two methods set forth below.

1^{ST} Method: Polycondensation

A mixture of titanium isobutoxide and acetylacetone in isobutanol and water is made.

Acetylacetone is a chelating agent which can delay hydrolysis. The reaction mixture contains suitable quantities of titanium isobutoxide, acetylacetone, isobutanol and water to obtain a polycondensate. In this respect, reference may be made to: Chemistry of Materials 1989, 1248-252.

2^{ND} Method: Hydrolysis then Peptization

A mixture of titanium isobutoxide and isobutanol is slowly added to a monovalent water and acid mixture. The white mixture obtained is left in an acid medium for a few days until it becomes fully transparent. In this respect, reference may be made to: Journal of Materials Science Letters, 1995, 14, 21-22.

The results obtained are given in TABLES 1 and 2 below.

TABLE 1 summarizes the results obtained with nanofiltration membranes comprising a support in titanium oxide, alumina or zirconium, a microfiltration layer in titanium oxide and optionally an ultrafiltration layer and a nanofiltration layer in titanium oxide obtained by polycondensation followed by sintering at 350° C. mₛ represents the density of the deposited nanofiltration layer.

TABLE 1

| | | | Permeability to | |
|---|---|---|---|---|
| | | mₛ | water | PEG retention |
| Support | ultrafiltration | (g/m²) | (l/(h · m² · b)) | 100 g/mol (%) |
| TiO₂ | no | 2 | 50 | 80 |
| | | 3 | 35 | 91 |
| | | 4 | 55 | 75 |
| Al₂O₃ | no | 2 | 120 | 25 |
| | | 3 | 110 | 55 |
| | | 4 | 140 | 15 |
| ZrO₂ | no | 2 | 90 | 65 |
| | | 3 | 60 | 75 |
| | | 4 | 80 | 66 |
| TiO₂ | ZrO₂ | 2 | 40 | 85 |
| | | 3 | 30 | 93 |
| | | 4 | 25 | 95 |
| Al₂O₃ | ZrO₂ | 2 | 110 | 35 |
| | | 3 | 110 | 40 |
| | | 4 | 90 | 55 |
| ZrO₂ | ZrO₂ | 2 | 80 | 75 |
| | | 3 | 70 | 75 |
| | | 4 | 65 | 80 |
| TiO₂ | TiO₂ | 2 | 35 | 84 |
| | | 3 | 26 | 94 |
| | | 4 | 21 | 98 |
| Al₂O₃ | TiO₂ | 2 | 100 | 33 |
| | | 3 | 110 | 38 |
| | | 4 | 100 | 54 |
| ZrO₂ | TiO₂ | 2 | 76 | 75 |
| | | 3 | 70 | 78 |
| | | 4 | 60 | 85 |

Table 2 summarizes the results obtained with nanofiltration membranes comprising a support in titanium oxide, alumina or zirconium, a microfiltration layer in titanium oxide, optionally an ultrafiltration layer and a nanofiltration layer in titanium oxide obtained by hydrolysis and peptization followed by sintering at 300° C.

TABLE 2

| | | | | PEG |
|---|---|---|---|---|
| | ultra- | | Permeability to water | retention 100g/ |
| Support | filtration | mₛ (g/m²) | (l/(h · m² · b)) | mol (%) |
| TiO₂ | no | 2 | 35 | 80 |
| | | 3 | 20 | 92 |
| | | 4 | 50 | 70 |
| Al₂O₃ | no | 2 | 55 | 65 |
| | | 3 | 50 | 69 |
| | | 4 | 100 | 30 |
| ZrO₂ | no | 2 | 45 | 69 |
| | | 3 | 40 | 75 |
| | | 4 | 80 | 45 |
| TiO₂ | ZrO₂ | 2 | 70 | 45 |
| | | 3 | 60 | 55 |
| | | 4 | 140 | 30 |
| Al₂O₃ | ZrO₂ | 2 | 200 | 15 |
| | | 3 | 180 | 20 |
| | | 4 | 250 | 5 |
| ZrO₂ | ZrO₂ | 2 | 150 | 30 |
| | | 3 | 140 | 35 |
| | | 4 | 250 | 10 |
| TiO₂ | TiO₂ | 2 | 65 | 65 |
| | | 3 | 60 | 55 |
| | | 4 | 130 | 35 |
| Al₂O₃ | TiO₂ | 2 | 130 | 35 |
| | | 3 | 135 | 35 |
| | | 4 | 200 | 10 |
| ZrO₂ | TiO₂ | 2 | 180 | 20 |
| | | 3 | 140 | 25 |
| | | 4 | 200 | 10 |

Among the membranes listed in TABLE 1, solely those membranes of the invention with a support in titanium oxide have a cutoff threshold in the order of 1 000 daltons corresponding to a molecular weight rejection rate of 90%.

These results show that when a support in titanium oxide is used, the nanofiltration membranes obtained have improved permeability to water and improved polyethylene glycol retention.

These results are in agreement with the value of the wetting angles of the supports used, which contribute towards the aspiration force and hence to the penetration velocity of the liquids inside the pores of the support. It appears that this velocity is lower the greater the angle, which should lead to slow structuring of the deposit which seems to better promote its quality.

In addition, it is preferable to use the hydrolysis and peptization method whenever the nanofiltration layers are deposited on microfiltration layers.

1. Inorganic nanofiltration membrane wherein it comprises:
a titanium oxide macroporous support;
one or several intermediate separation layers; and
an upper metal oxide nanofiltration separation layer.

2. Inorganic nanofiltration membrane as in claim 1, wherein its cutoff threshold lies between 100 and 2000 daltons, preferably between 800 and 2000 daltons.

3. Inorganic nanofiltration membrane as in claim 1, wherein it is of tubular or planar conformation.

4. Inorganic nanofiltration membrane as in claim 2, wherein it is of tubular or planar conformation.

5. Inorganic nanofiltration membrane as in claim 1, wherein the nanofiltration separation layer has a density of between 2 and 4 g/m², preferably of 3 g/m².

6. Inorganic nanofiltration membrane as in claim 1, wherein the upper nanofiltration separation layer is in titanium oxide.

7. Inorganic nanofiltration membrane as in claim 1, wherein the intermediate separation layer is a microfiltration layer in metal oxide.

8. Inorganic nanofiltration membrane as in claim 7, wherein the microfiltration layer is in titanium oxide.

9. Inorganic nanofiltration membrane as in claim 1, wherein the intermediate separation layer comprises an ultrafiltration layer in metal oxide deposited on a microfiltration layer in metal oxide, itself deposited on the support.

10. Inorganic nanofiltration membrane as in claim 9, wherein the ultrafiltration layer is in titanium oxide.

11. Inorganic nanofiltration membrane as in claim 9, wherein the ultrafiltration layer is in zirconium oxide.

12. Inorganic nanofiltration membrane as in claim 9, wherein the microfiltration layer is in titanium oxide.

13. Inorganic nanofiltration membrane as in claim 1, wherein the nanofiltration layer of metal oxide is obtained using a method comprising the following steps:
formation of a sol by polycondensation of an alkoxide of the corresponding metal in an alcohol medium and in the presence of a chelating agent;
depositing said sol on the support or the intermediate separation layer;
drying said sol to form a gel; and
sintering the gel obtained.

14. Inorganic nanofiltration membrane as in claim 1, wherein the nanofiltration layer of metal oxide is obtained using a method comprising the following steps:
formation of a sol by hydrolysis of an alkoxide of the corresponding metal followed by peptization;
depositing said sol on the support or the intermediate separation layer;
drying said sol to form a gel; and
sintering the gel obtained.

15. Inorganic nanofiltration membrane as in claim 10, characterized in that the microfiltration layer is in titanium oxide.

16. Inorganic nanofiltration membrane as in claim 11, characterized in that the microfiltration layer is in titanium oxide.
